(19) United States
(12) Patent Application Publication
(10) Pub. No.: US 2023/0193608 A1
(43) Pub. Date: Jun. 22, 2023

(54) FLOOD DETECTION CONTROL DEVICE FOR REDUCED PRESSURE BACKFLOW PREVENTERS

(71) Applicant: Aalberts integrated piping systems Americas, Inc., Charlotte, NC (US)

(72) Inventors: Julie C. Howell, Indian Trail, NC (US); Dan Yin, Waxhaw, NC (US); Bertito T. Rodriguez, Charlotte, NC (US)

(21) Appl. No.: 18/073,717

(22) Filed: Dec. 2, 2022

Related U.S. Application Data
(60) Provisional application No. 63/290,141, filed on Dec. 16, 2021.

(51) Int. Cl. E03C 1/05; E03C 1/10; G05B 23/02

(52) U.S. Cl. CPC E03C 1/057; E03C 1/102; G05B 23/0272

(57) ABSTRACT

A flood control device for detecting discharge from a release outlet, comprising a receptacle having an upper opening, a bottom, and a drain hole; a first water level sensor configured to be triggered by water reaching a first level; a second water level sensor configured to be triggered by water reaching a second level, wherein the first water level sensor is closer to the bottom of the receptacle than the second water level sensor, wherein triggering the first water level sensor represents a low flow signal, and triggering both the first water level sensor and the second water level sensor represents a high flow signal. The low flow signal can be used to trigger a warning, and the high flow signal can be used to trigger automatic shutoff and/or shutoff alarm.

### FIELD OF THE INVENTION

The herein disclosed invention directs to flood detection and control devices typically used with backflow preventer valves.

### BACKGROUND OF THE INVENTION

A Reduced Pressure Principle Backflow Preventer (RP, e.g., Apollo® Model RP4A) is designed to control cross-connections between potable water lines and substances that are health hazards or non-health hazards. The device consists of two independently acting, spring loaded check valves with a diaphragm actuated, spring-loaded relief valve (RV) located between the checks. The device is equipped with four test cocks and inlet and outlet shutoff valves.

During normal flow conditions, the two check valves open, supplying water downstream. The relief valve is held closed by supply pressure acting through a sensing passage on the RV diaphragm. The area between the checks, called the “zone,” is typically maintained at a minimum of 5 psi lower than supply pressure. Should a backpressure or back-siphonage condition occur, the No. 2 (downstream) check will close to prevent backflow. Should the No. 2 check become fouled during a backpressure or back-siphonage situation, the zone pressure will increase causing the relief valve to open. This will maintain the pressure in the zone at least 2 psi lower than the supply pressure.

Many RPs are installed indoors to protect them from freezing. The RPs are often installed in a basement or other out-of-the-way location. If water discharges from the relief valve, whether due to supply pressure fluctuations or fouled check valves, it can go unnoticed. To accommodate minor RV discharge, many backflow manufacturers offer an “air gap drain” (AGD) accessory. The AGD attaches directly to the backflow preventer. Outlet piping is then attached to the AGD to route discharged water to a floor drain. AGDs are typically not intended to collect more than minor RV discharge, such as spitting, dripping, or light sustained leaking. If a catastrophic event occurs causing the RV to discharge excessively, the AGD will quickly overflow resulting in possible flooding.

An air gap is one of the oldest and most reliable forms of backflow prevention. A physical air gap is the unobstructed vertical distance between the water outlet and the rim of the receptacle (similar to a faucet and sink rim). For example, ANSI/ASME A112.1.2 defines the vertical distance as a function of the diameter of the water discharge port. In an exemplary embodiment presented in this disclosure, the discharge port diameter is 1-½″. Per ANSI/ASME A112.1.2, the vertical distance required for the air gap drain to be in compliance is two times the discharge port diameter, therefore three inches.

### SUMMARY OF THE INVENTION

According to one aspect of the invention, a flood control device is provided for detecting discharge from a release outlet, comprising: a receptacle having an upper opening, a bottom, and a drain hole, wherein the drain hole is offset to one side of the receptacle and having a size smaller than the upper opening; and a first water level sensor configured to be triggered by water reaching a first level; a second water level sensor configured to be triggered by water reaching a second level, wherein the first water level sensor is closer to the bottom of the receptacle than the second water level sensor, wherein triggering the first water level sensor represents a low flow signal, and triggering both the first water level sensor and the second water level sensor represents a high flow signal.

The flood control device according to the one aspect of the invention may further comprise an anti-splash guard close to the upper opening of the receptacle.

The flood control device according to the one aspect of the invention may further comprise a water level sensor compartment in fluid communication with the receptacle, wherein the first and second water level sensors are located.

In the flood control device according to the one aspect of the invention, the bottom of the receptacle may be angled toward the water level sensor compartment.

In the flood control device according to the one aspect of the invention, the bottom of the receptacle may further comprise a drain channel leading to the drain hole of the receptacle.

In the flood control device according to the one aspect of the invention, the first water level sensor may be in a normally open state, and is changed to a closed state when water reaching the first level.

In the flood control device according to the one aspect of the invention, the second water level sensor may be in a normally open state, and changed to a closed state when water reaching the second level.

In the flood control device according to the one aspect of the invention, wherein the first water level sensor may be in a normally closed state, and is changed to an open state when water reaching the first level.

In the flood control device according to the one aspect of the invention, wherein the second water level sensor is in a normally closed state, and is changed to an open state when water reaching the second level.

The flood control device according to the one aspect of the invention may further comprise a controller connected to the first and second water level sensor.

In the flood control device according to the one aspect of the invention, the controller may send a low flow warning message when a low flow signal is detected.

In the flood control device according to the one aspect of the invention, the warning message can be audio, visual, or electronic.

In the flood control device according to the one aspect of the invention, the controller may send a water shutoff command and a water shutoff alarm, when a high flow signal is detected.

The flood control device according to the one aspect of the invention may be adapted to be installed under a reduced pressure backflow preventer.

In the flood control device according to the one aspect of the invention, the upper opening may be about 3 in. from the release outlet of the reduced pressure backflow preventer.

In the flood control device according to the one aspect of the invention, further comprising a mounting adapter, which secures the flood control device to the reduced pressure backflow preventer, and maintain an appropriate air gap distance from the release outlet.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows an exemplary reduced pressure backflow preventer assembly with an attached exemplary embodiment of the flood control device;

FIG. 2 is an exploded view of an exemplary embodiment of the flood control device showing major components of the embodiment;

FIGS. 3A-C show top, front and a cross-sectional view along line 3C-3C of a receptacle of an exemplary embodiment of the flood control device;

FIGS. 4A and 4B show a side view and a cross-sectional view along line 4B-4B in FIG. 4A of a receptacle of an exemplary embodiment of the flood control device;

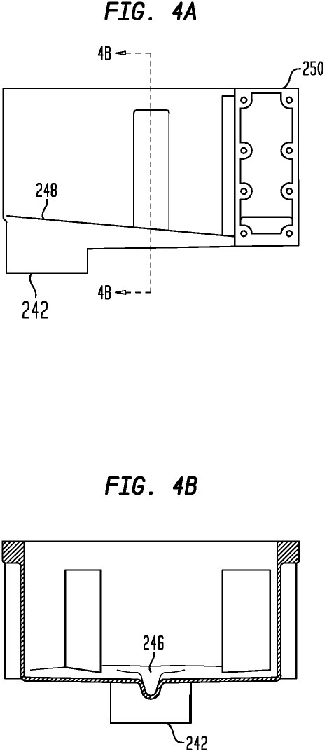

FIG. 5A and B show a side view and a cross-sectional view along line 5B-5B in FIG. 5A of a receptacle of an exemplary embodiment of the flood control device;

FIGS. 6A-C show a side view, a cross-sectional view along line 6B-6B in FIG. 6A, and cross-sectional view in the direction along the drain channel of a receptacle of an exemplary embodiment of the flood control device;

FIGS. 7A-C show a side view, a cross-sectional view along line 7B-7B in FIG. 7A, and cross-sectional view in the direction along the drain channel of a receptacle of an exemplary embodiment of the flood control device;

FIG. 8 shows a schematic diagram of the controller in the control box of an exemplary embodiment of the flood control device; and

FIG. 9 shows an exemplary logic diagram of the controller of an exemplary embodiment of the flood control device.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

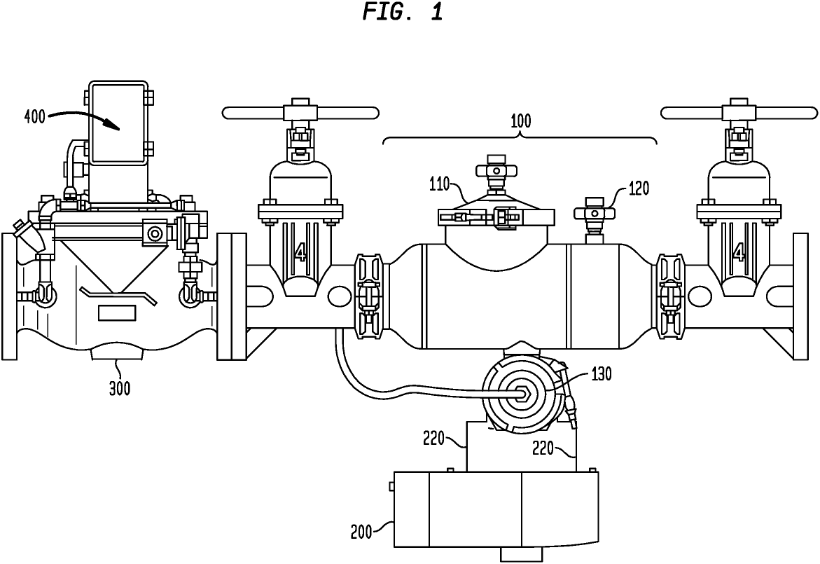

FIG. 1 shows an exemplary reduced pressure (RP) backflow preventer assembly 100 with an attached exemplary embodiment of the flood control device 200. The RP backflow preventer 100 shown also has an automatic control valve (ACV) 300 installed at the inlet end of the RP backflow preventer 100. The ACV 300 can be controlled via external signal to shutoff water flow to the RP in case of malfunction, repair, maintenance, or other situations that require water supply to be shutoff. The external signal typically controls the ACV 300 via electronic installed in the control box 400. The RP backflow preventer 100 typically comprises two tandemly installed check valves 110120. There is typically relief valve (RV) 130 between the two check valves 110120. In case of malfunction, water can be discharged from the RV 130.

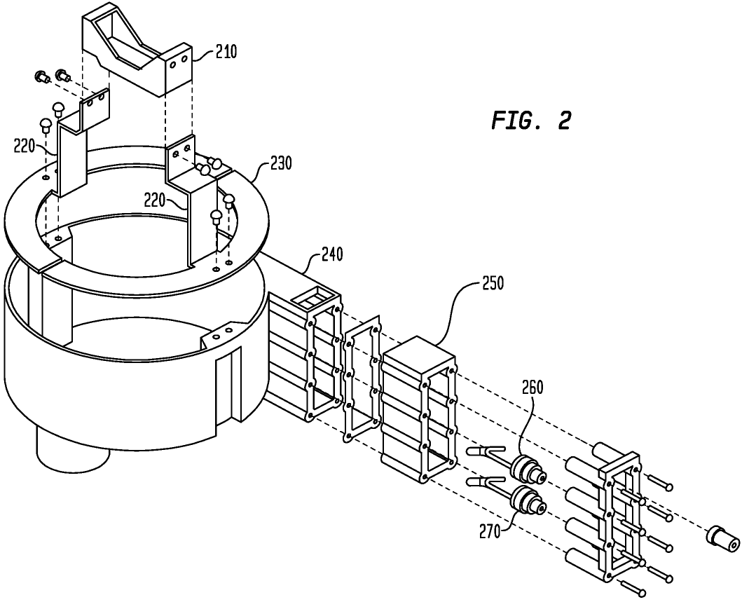

Referring to FIGS. 1 and 2, the exemplary embodiment of the Flood Control Device 200 comprises an adapter 210 to connect to the RP backflow preventer’s relief valve 130. In the embodiment shown, an anti-splash ring 230 is integrated into straps 220 connecting the adapter 210 to the receptacle 240. The purpose of the anti-splash rings 230 is to redirect water that flows up the sides of the receptacle 240 during high discharge events. At high discharge flow rate, water tends to splash along the receptacle wall. Tests have shown that the anti-splash rings 230 is beneficial in retaining discharged water within the receptacle 240, and directing the discharged water into the water level sensor compartment 250. The straps 220 maintain proper air gap distance between the discharge port and the receptacle, for example, ensure that the assembled device complies with ASME A112.1.2. In this example, the air gap requirement is three inches. However, this dimension is dependent on the diameter of the RV discharge port. As such, the air gap height can vary accordingly. In this embodiment, the straps 220 and the anti-splash ring 230 are shown to be integral. However, each functionality can be achieved as separate components, or integral with other components of the flood control device 200. Two water level sensors 260270, in this particular embodiment two identical commercially-available float switches, are located in a sensor compartment 250. The two sensors 260270 are installed one above the other. In this embodiment, water level sensor 260 is installed above the water level senor 270. In this embodiment shown, the water level sensors 260270 are float level switches, which can be installed as normally open. In operation, a float within the float level switch would respond to rising water level and closed the circuit when the water level exceeds a predetermined level. The sensor compartment 250 can be sealed to the receptacle 240 with a rubber gasket. Within the water level sensor compartment 250, a four-conductor cable is attached to the float switches’ fly leads with waterproof wire splices. The cable is then fed through a cable gland securely attached to the float switch compartment cover. It must be emphasized that cabling for the water level sensors 260270 depends on the nature of the sensors installed, and may vary from the exemplary embodiment shown. Torx screws are used to attach the float switch compartment and cover to the receptacle. The use of torx screws is meant to be a deterrent for removing the cover in the field. Such choices of fasteners and means for attaching the components are also with the scope of the design choices of one skilled in the art. An exploded view of the component is shown in FIG. 2.

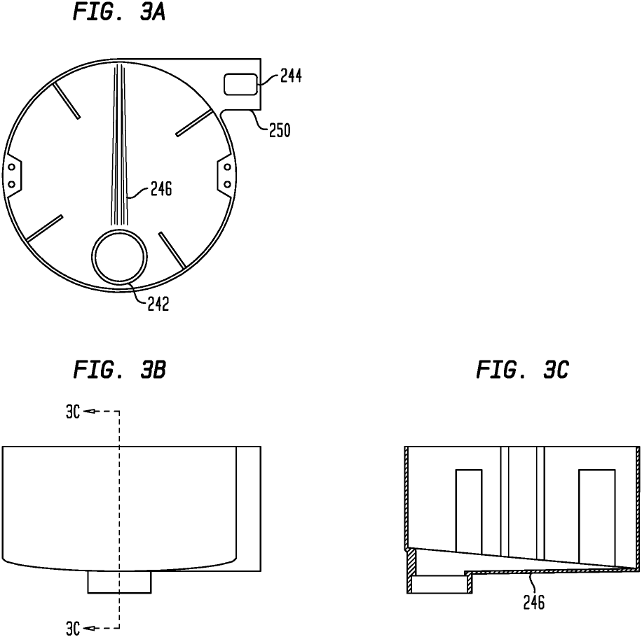

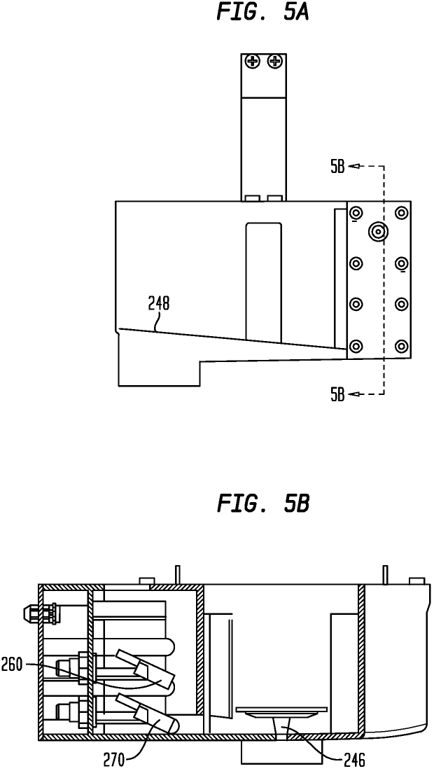

FIG. 3A shows the top view of the AGD receptacle 240 with an offset drain hole 242. The receptacle’s angled bottom 248 (FIGS. 5A, 6A, and 7A) directs discharged water toward the float switch chamber 250, rather than toward the drain hole 242. The bottom surface includes an angled drain channel 246 to route standing water to the outlet drain hole 242 once water flow has stopped.

Discharged water from the relieve valve discharge port is directed toward the float switch chamber 250 by the angled bottom 248. The water level sensor (in this embodiment float switch) chamber 250 is typically gasket-sealed and reasonably watertight, so that discharge water can accumulate in the water sensor chamber 250. Water enters the sensor chamber 250 via the angled bottom 248 of the receptacle 240, when the rate of discharge exceeds rate of draining from the outlet drain hole 242. As the water level rises, a vent 244 at the top of the receptacle 240 allows displaced air to escape.

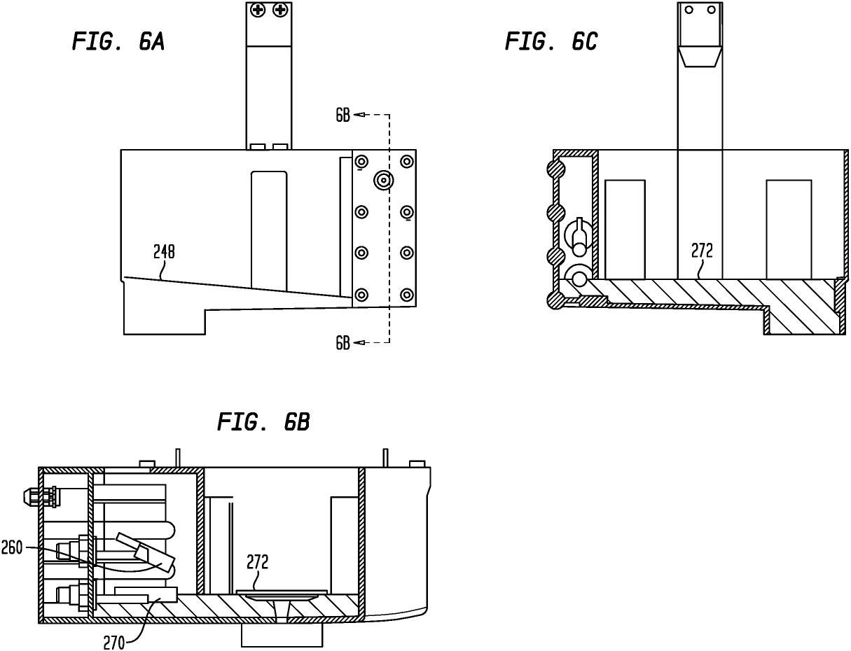

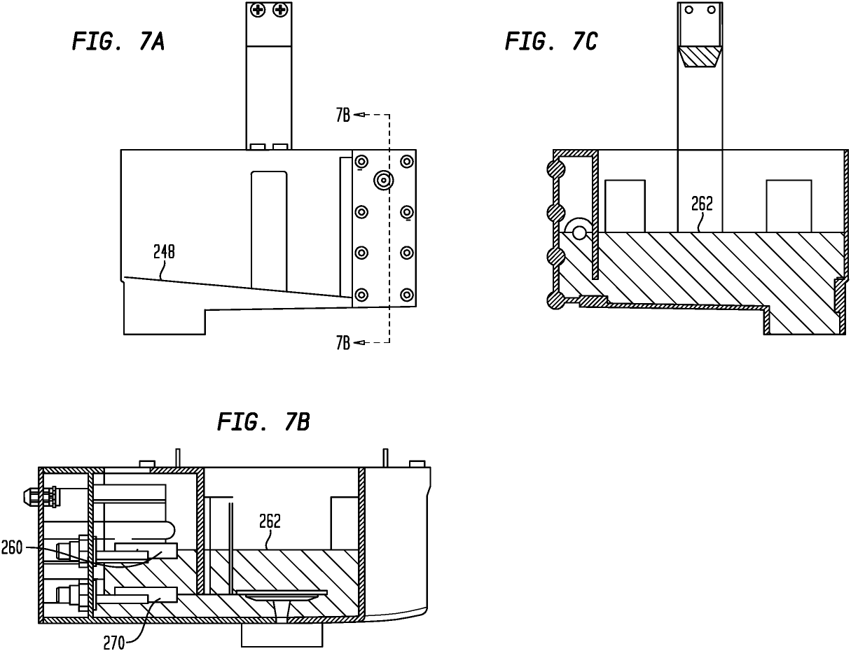

FIGS. 5A, 6A, and 7A are side view of the receptacle 240 and water level sensor chamber 250. FIG. 5B is a cross-sectional view along the line 5B-5B. FIG. 6B is a cross-sectional view along the line 6B-6B. FIG. 6C is a cross-sectional of the receptacle in a direction along the drain channel 246. FIG. 7B is a cross-sectional view along the line 7B-7B. FIG. 7C is a cross-sectional of the receptacle in a direction along the drain channel 246. The position of the float switches 260270 in the views of FIGS. 5A-B, 6A-C and 7A-C show the water level required to activate each of the two water level sensors 260270. FIGS. 5A-B show both of the float switches 260270 in the normally open condition, which indicates no discharge flow, and no signal to the control box 400. FIGS. 6A-C shows a small amount of discharge water enters the receptacle 240 at a relatively low flow rate, and the water level rises to a level 272 required to activate the bottom switch 270. In testing with this particular embodiment, this water level occurs around 1-2 gallons per minute (gpm). While this amount of water will easily drain away, it may not be desirable to waste this amount of water on a continuous basis. The bottom float switch 270 will activate (FIGS. 6B and 6C), alerting the Building Management System (BMS) and/or Maintenance personnel that attention is needed for the backflow preventor. The water supply will not be automatically shutoff under this condition. However, if water discharge from the backflow preventer increases (e.g., in this embodiment to 10-20 gpm), the water level in the tank continue to rise to a higher level 262 and eventually activates the bottom switch 270 and top switch 260. When the top switch 260 is activated, a signal is sent to the control box 400, which then operates the Automatic Control Valve (ACV) 300. Typically, such operation of the ACV is via the actuation of a solenoid valve. The solenoid valve signals the pilot valve to close the ACV. The speed of the ACV closure can be controlled with a needle valve integral to the ACV. Once the solenoid signal is received, it takes approximately 2-3 seconds to close the ACV. The BMS and/or maintenance personnel are alerted simultaneously that water has been shutoff. The water supply cannot be reestablished until the backflow preventer is inspected and the ACV and flood control device reset.

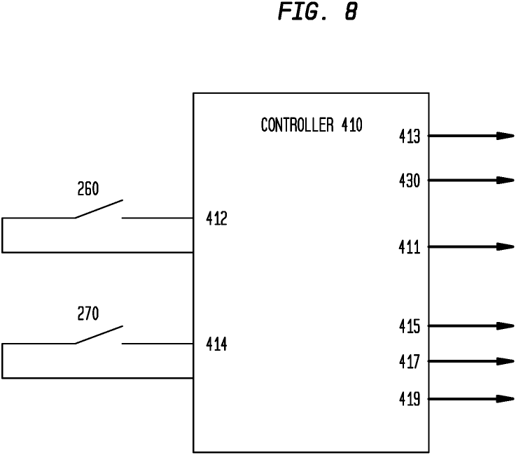

FIG. 8 shows a schematic diagram of the controller 410 installed in the control box 400. As shown in FIG. 8, the controller 410 comprises I/O interfaces 411-415 and 417 and a networking interface 430. The networking interface 430 may comprise a communication module that supports WiFi, Ethernet, ZigBee, LoRa, or other telecommunication protocol, so that the controller 410 may send messages, for example, an email or a text, by I/O interface 413 through the networking interface 430.

The I/O interfaces 412 and 414 are input interfaces that are connected to and thus receive the ON/OFF signal from the switches 260 and 270, respectively. For example, when the switches 260 and 270 are normally open, the controller 410 Normally receives an OFF signal from the switches 260 and 270 through the input interfaces 412 and 414. When the water level in the tank rises to a level 272 and activates the bottom switch 270, the input interface 414 receives an ON signal indicating a closed circuit by the switch 270. When the water level in the tank continues rising to a level 262 and activates the top switch 260, the input interface 414 receives an ON signal indicating a closed circuit by the switch 270.

The output interface 411 sends ON/OFF signal to ACV thus controls the ACV to open or close. The output interface 413 sends email notification through the networking interface 430. The output interface 415 sends alarm ON/OFF signal to the BMS or building management personnel while the output interface 417 sends warning ON/OFF signal to the BMS. A warning ON signal will activate a warning device at the BMS, which can be audio, visual, or electronic (such as a text, email, or other type of message). An alarming ON signal will activate an alarming device at the BMS, which may also be audio, visual or electronic, that is different from that made by the warning device. The output interface 419 outputs ON signal to BMS when the controller is powered, and an OFF signal to BMS when the controller is not powered indicating a malfunction of the controller or a power outage.

As aforementioned, when the controller 410 receives an ON signal from the switch 270 but an OFF signal from the switch 260, it indicates that the water level has risen above the level 272 but below the level 262. This indicates a low rate of water leaking that needs attention, but it is not desirable to shut off the water supply. The controller 410 may be configured to send ON signal through the output interfaces 413 and 417, sending email or text notification and warning to BMS, keep ON signal at the output interface 411 to keep the ACV open, and OFF signal at the output interface 415 so as not to activate the alarm.

In this exemplary embodiment, the controller 410 comprises an ABX00021 of Arduino control board, which is commercially known as “ARDUINO UNO WIFI REV2.” Other commercially available or customized PCB board can be used.

In addition to the I/O interfaces and network interface, the controller usually further comprises a configuration button for initiating the configuration of the controller and a reset button for restarting the controller, which will be described later.

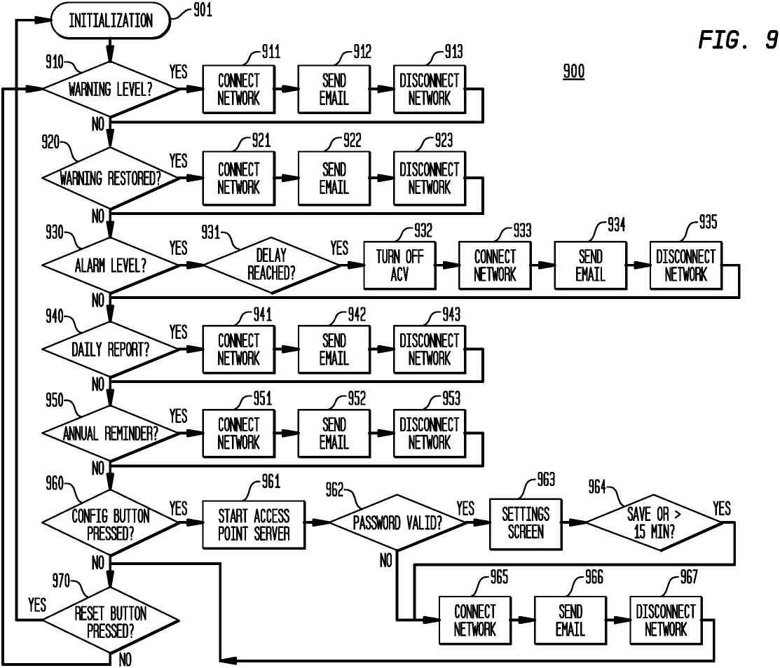

FIG. 9 shows an exemplary logic diagram 900 of the controller 410. The logic diagram 900 is an exemplary routine run by the controller. As shown in FIG. 9, when the flood control device 200 is installed and powered, the controller initializes at 901.

When the water rises to the level 272 and thus activates the switch 270, the controller 410 detect a warning level of water at 910, that is, the low flow of water. The controller 410 then connects the network through the network interface 430, send a warning email, and disconnect the network, as shown by 911-913. Additionally or alternatively, the controller 410 may also send warning ON signal to BMS through the output interface 415 (not shown in FIG. 9).

In this case, when the water level decrease below the level 272 at 920, the controller 410 then connects the network through the network interface 430, send an email indicating that the warning is clear, and disconnect the network, as shown by 921-923.

Otherwise, if the water level keeps rising to above the level 262 (that is, high flow of water or alarm level) and thus activates the switch 260, the controller 410 receives the ON signal from the switch 260. As shown at 931, the controller 410 will wait for a predetermined delay (e.g., in a range of 0-1000 seconds, preferably 1-99 seconds). If the signal keeps ON from the switch 260 for the predetermined delay, the controller determines that a substantial water leak that requires ACV to be shutoff, and thus turns off ACV, connects network, send email regarding the leak and ACV shutoff, disconnects network, as shown by 932-935. The delay of predetermined time may prevent false alarm caused by the splash of water that causes temporary close circuit of the switch 260. Usually, the longer the delay is, the better it may prevent nuisance caused by intermittent alarms while the sensitivity of leak detection is lower. When the predetermined time is set at 0, the ACV shutoff and alarm notification as shown by 932-935 will be triggered immediately once the signal from switch 260 becomes ON. In another embodiment, the predetermined time is configurable by the end user. For example, the controller 410 may be configured to allow the user to adjust the predetermined delay at integer values or in a stepless manner. Additionally or alternatively, the controller 410 may also send alarm ON signal to BMS through the output interface 417 (not shown in FIG. 9).

As shown in FIG. 9, if both switch 260 and 270 are open (OFF) and thus no leak was detected, the routine 900 will then run some additional function subroutines as shown by 940- 970. At 940, the controller 410 will check if it is a daily report time that is preset (usually end of a day), and, if yes, the controller 410 will connect the network, send a daily report email containing all the warning/alarming incident occurred in the day, and then disconnect the network, as shown by 941-943. At 950, the controller 410 will check if it is an annual remind time that is preset (usually the same day of a year), and, if yes, the controller 410 will connect the network, send an annual reminding email reminding an annual check, and then disconnect the network, as shown by 951-953.

The routine 900 will then go to step 960 to check if the configuration button of the control box is pressed. If yes, the configuration subroutine will run according to steps 961-967. Specifically, the controller 410 will start an access point server at 961, and request password at 962. If the input password is not valid, the subroutine will go to steps 965-967, sending a notification email before exiting the subroutine. Otherwise, the subroutine will receive the configuration of the controller. If the configuration is saved or there is no input for a predetermined time period (15 minutes, for example), the subroutine will go to steps 965-967, sending a notification email before exiting the subroutine.

The routine 900 will then go to subroutine 970 to check if reset button of the controller box is pressed. If yes, the routine will go to 901 and restart the controller. Otherwise, the routine will go back to 910 and recheck if the switch 270 is ON or OFF.

Steps 940-970 and their subroutines are examples, and the routine may not include one or more of them. In another example, one or some of the steps 940-970 and their subroutines can be run independently from the routine 900.

Likewise, steps 910-930 can also run independently instead of running in the same routine. When run in the same routine, the order of the steps may also be changed according to the desirable priority and configuration. In the example shown in FIG. 9, the routine 900 will only check the signal from the top switch 260 when having received a positive result of warning or low flow level from the bottom switch 270. This may avoid the false alarm when a ON signal is received from the top switch 260 while an OFF signal is received from the bottom switch 270, which usually indicates a malfunction in any of the switches or in the controller. In the other example, the signals from the two switches can be detected independently and thus may output a warning or alarming of malfunction when a ON signal is received from the top switch 260 while an OFF signal is received from the bottom switch 270.

The steps 910-930 may run continuously or periodically at a defined frequency, such as 50-1000 ms. Polling the sensors 260270 periodically may help preserve battery power. Only connecting to the network when a warning or alarm signal is received, or a warning signal is restored also help to preserve battery power.

It should be understood that modifications to the embodiments disclosed herein can be made to meet a particular set of design criteria. The particular configuration of type of such components can also be adjusted to meet a particular set of design criteria. Therefore, while certain exemplary embodiments of devices and methods of making and using the same have been discussed and illustrated herein, it is to be distinctly understood that the invention is not limited thereto but may be otherwise variously embodied and practiced within the scope of the following claims.

What is claimed is:

1. A flood control device for detecting discharge from a release outlet, comprising:
a receptacle having an upper opening, a bottom, and a drain hole, wherein the drain hole is offset to one side of the receptacle and having a size smaller than the upper opening; and
a first water level sensor configured to be triggered by water reaching a first level;
a second water level sensor configured to be triggered by water reaching a second level, wherein the first water level sensor is closer to the bottom of the receptacle than the second water level sensor,
wherein triggering the first water level sensor represents a low flow signal, and triggering both the first water level sensor and the second water level sensor represents a high flow signal.

2. The flood control device according to claim 1, further comprising an anti-splash guard close to the upper opening of the receptacle.

3. The flood control device according to claim 1, further comprising a water level sensor compartment in fluid communication with the receptacle, wherein the first and second water level sensors are located.

4. The flood control device according to claim 1, wherein the bottom of the receptacle is angled toward the water level sensor compartment.

5. The flood control device according to claim 4, wherein the bottom of the receptacle further comprising a drain channel leading to the drain hole of the receptacle.

6. The flood control device according to claim 1, wherein the first water level sensor is in a normally open state, and is changed to a closed state when water reaching the first level.

7. The flood control device according to claim 1, wherein the second water level sensor is in a normally open state, and is changed to a closed state when water reaching the second level.

8. The flood control device according to claim 1, wherein the first water level sensor is in a normally closed state, and is changed to an open state when water reaching the first level.

9. The flood control device according to claim 1, wherein the second water level sensor is in a normally closed state, and is changed to an open state when water reaching the second level.

10. The flood control device according to claim 1, further comprising a controller connected to the first and second water level sensors.

11. The flood control device according to claim 10, wherein the controller will send a low flow warning message when a low flow signal is detected.

12. The flood control device according to claim 11, wherein the warning message can be audio, visual, or electronic.

13. The flood control device according to claim 10, wherein the controller sends at least one of a water shutoff command and a water shutoff alarm, when a high flow signal is detected.

14. The flood control device according to claim 10, wherein the controller sends at least one of a water shutoff command and water shutoff alarm after a predetermined delay, when a high flow signal is detected.

15. The flood control device according to claim 14, wherein the predetermined delay is configurable.

16. The flood control device according to claim 1, adapted to be installed under a reduced pressure backflow preventer having a release outlet.

17. The flood control device according to claim 16, wherein the upper opening is about 3 in. from the release outlet of the reduced pressure backflow preventer.

18. The flood control device according to claim 17, further comprising a mounting adapter, which secures the flood control device to the reduced pressure backflow preventer, and maintains an air gap distance to be about two times of a diameter of the release outlet.
